(19) United States
(12) Patent Application Publication
(10) Pub. No.: US 2025/0116413 A1
(43) Pub. Date: Apr. 10, 2025

(54) ELECTRIC RADIATOR FOR A VENTILATION, HEATING AND/OR AIR-CONDITIONING SYSTEM

(71) Applicant: VALEO SYSTEMES THERMIQUES, La Verriere (FR)

(72) Inventor: Romain DELCOURT, La Verriere (FR)

(73) Assignee: VALEO SYSTEMES THERMIQUES, La Verriere (FR)

(21) Appl. No.: 18/687,144

(22) PCT Filed: Aug. 30, 2022
(86) PCT No.: PCT/EP2022/074010

§ 371 Date: Feb. 27, 2024

(30) Foreign Application Priority Data
Sep. 3, 2021 (FR) 2109269

(51) Int. Cl. F24F 1/0093

(52) U.S. Cl. CPC F24F 1/0093

(57) ABSTRACT

An electric radiator for a ventilation, heating and/or air-conditioning system of a motor vehicle, including at least one heating element forming a heating body and an electronic control device of the at least one heating element housed in a housing, the heating body and the housing being integral with each other. The electric radiator includes a separating wall arranged between the housing and the heating body. The radiator includes at least one support for at least one temperature sensor, the support being arranged such as to at least partially overlap with the at least one heating element in the heating body. The electric radiator includes an electronic connecting element between the at least one temperature sensor and the electronic control device. The separating wall includes at least one orifice configured to be traversed by the electronic connecting element.

### TECHNICAL FIELD

The present invention pertains to the field of ventilation, heating and/or air-conditioning systems for motor vehicles, and relates more particularly to an electric radiator of such ventilation, heating and/or air-conditioning systems.

### BACKGROUND OF THE INVENTION

Motor vehicles are generally provided with a ventilation, heating and/or air-conditioning system that makes it possible to circulate an air flow toward the passenger compartment of the motor vehicle and, depending on the temperature of the passenger compartment desired by the driver and/or passengers of the motor vehicle, to heat and/or cool the air flow sent to the passenger compartment. Such ventilation, heating and/or air-conditioning systems thus comprise at least one member for circulating the air flow and an electric radiator capable of heating the air flow circulated toward the passenger compartment.

It is known practice for the electric radiators of these ventilation, heating and/or air-conditioning systems to comprise a heating body, in which heating elements are arranged across an air flow to be heated, and at least one electronic device for controlling the heating elements. The electronic control device generally comprises a housing inside which is arranged a printed circuit board on which are installed various electronic components that contribute to the generation of a command instruction to be sent to the heating elements so that they heat. Thereafter, the heating elements are capable of increasing in temperature and the air flow circulating between the tubes of the electric radiator is heated as it circulates between the tubes.

The electric radiator can further comprise a temperature sensor intended to measure the temperature of the heating elements and/or of the air flow circulating between the heating elements. The information gathered by the temperature sensor is then transmitted to the electronic control device so that it adjusts the temperature of the heating elements and thus thermally regulates the air flow.

In these electric radiators of the prior art, the coupling between the temperature sensor and the electronic control device is provided by an electronic connection element that is connected to one end of the temperature sensor, which extends along the heating body of the electric radiator and is coupled to a lateral face of the housing, at a distance from the heating body, and as close as possible to a connector fastened to the printed circuit board. As a result of this configuration, at least one portion of the cable forming the electronic connection element extends at a distance from the heating body and the housing, and this portion is susceptible to damage. Specific sealing of the coupling between the cable and the housing must also be carried out.

### SUMMARY OF THE INVENTION

In this context, the main object of the present invention is an electric radiator of a ventilation, heating and/or air-conditioning system of a motor vehicle, the radiator comprising at least one heating element forming a heating body and an electronic device for controlling the at least one heating element accommodated in a housing, the heating body and the housing being rigidly connected to each other, the electric radiator comprising a separating wall arranged between the heating body and the housing, the radiator comprising at least one support for at least one temperature sensor, the support being positioned at least partially covering the heating element(s) in the heating body, the electric radiator comprising an electronic connection element between the at least one temperature sensor and the electronic control device, characterized in that the separating wall comprises at least one orifice configured to be passed through by the electronic connection element.

The electric radiator contributes to the heating of an air flow circulating in the vicinity of the at least one heating element. Advantageously, the electric radiator comprises a plurality of heating elements positioned parallel alongside each other, the air flow circulating between the heating elements in order to be heated.

The temperature sensor makes it possible to measure the temperature of the at least one heating element and/or of the air flow circulating around the at least one heating element and to transmit the information gathered to the electronic control device. The electronic control device can then send, for example, a command instruction to the at least one heating element so that its temperature is adjusted to a target temperature.

In this context, the connection element is the component of the electric radiator that provides the electrical connection between the temperature sensor and the electronic control device. This connection element can for example take the form of a cable extending between the temperature sensor and the electronic control device, this cable being for example connected to a connection block of the electronic control device. It will be understood here that the information gathered by the temperature sensor is then transmitted to the electronic control device via the connection element.

According to the invention, the connection element extends through the separating wall. The connection element thus comprises a first portion in contact with the temperature sensor extending between the temperature sensor and the orifice of the separating wall, and a second portion in contact with the electronic control device extending between the electronic control device and the orifice of the separating wall. It is particularly advantageous according to the invention that the connection element accesses the housing of the electronic control device by passing through the separating wall that is arranged between this housing and the heating body, as this makes it possible to reduce the path of the connection element and avoid it extending outside the electric radiator in order to be connected to a lateral face of the housing. The connection element can thus very particularly be protected from shearing, for example.

According to one optional feature of the invention, the support comprises a member for guiding the connection element protruding from the support toward the electronic control device, the guide member extending through the separating wall in said orifice.

The guide member can advantageously be formed from a more rigid material than the connection element and thus contributes to mechanically guiding the connection element from the support toward the electronic control device through the orifice of the separating wall.

According to another optional feature of the invention, the guide member has a first part, which extends perpendicular to the main plane of extension of the support, and a second part that extends the first part toward the electronic control device and is positioned through the orifice formed in the separating wall, the electronic connection element being positioned along the first part and the second part.

According to another optional feature of the invention, the second part of the guide member can have a U-shaped profile when viewed in a cross-section perpendicular to the main direction of extension. It will be understood that the guide member comprises a central wall and two lateral walls each extending from one of the ends of the central wall. This U shape makes it possible to accommodate and protect the wire or cable forming the connection element.

According to another optional feature of the invention, the support takes the form of a grille in which the at least one temperature sensor is installed, the grille being positioned facing the heating body. The term grille refers to a structure that is sufficiently rigid to hold the temperature sensor in place and protect the connection element when it extends along the support, while allowing through an air flow that has passed through the heating body and the heating elements facing which the support is positioned. The support can in particular comprise a plurality of transverse and longitudinal bars, at least one of which extends across the heating body to hold the temperature sensor and position it substantially in the center of the heating body.

According to another optional feature of the invention, the guide member is positioned in a corner of the grille forming the support.

According to another optional feature of the invention, the housing comprises a plurality of walls that contribute to the definition of a space for receiving the electronic control device, at least a bottom wall of which takes the form of a bowl, the bottom wall of the housing forming said separating wall between the housing and the heating body. It will be understood here that the orifice through which the guide member and the connection element extend is positioned in the bottom wall of the housing.

According to another optional feature of the invention, the radiator comprises an additional element installed between the housing and the heating body, the additional element contributing to the formation of said separating wall. In this configuration, the additional element can be combined with the bottom wall of the housing in order to form the separating wall.

According to another optional feature of the invention, the bottom wall and the additional element each comprise an orifice, the orifice of the bottom wall being aligned with the orifice of the additional element, each of the orifices being configured to be passed through by the electronic connection element, and if applicable the guide member.

According to another optional feature of the invention, the electric radiator comprises at least one sealing element installed between the guide member and the separating wall. The sealing element prevents the circulation of a fluid at least through the orifice of the separating wall, hermetically sealing the housing in which the electronic control device is accommodated from the receiving recess at least partially delimited by the frame.

According to another optional feature of the invention, the separating wall comprises an opening through which the at least one heating element and/or the coupling member of the at least one heating element extend(s), the orifice configured to be passed through by the electronic connection element communicating with said opening.

According to another optional feature of the invention, the electric radiator comprises a plurality of heating elements installed alongside each other, the separating wall comprising a set of openings installed alongside each other and sized so as to respectively receive and be passed through by a heating element of the radiator, the orifice configured to be passed through by the electronic connection element communicating with one of the two openings positioned at the end of the set of openings.

The present invention also relates to a ventilation, heating and/or air-conditioning system comprising at least one circulation duct capable of directing an air flow, the ventilation, heating and/or air-conditioning system comprising at least one ventilation member forcing the circulation of the air flow through the circulation duct and an electric radiator installed in the duct, the radiator being characterized according to any one of the preceding features, the at least one heating element being installed across the circulation duct.

### BRIEF DESCRIPTION OF DRAWINGS

Further features, details and advantages of the invention will become more clearly apparent from reading the following description and a number of exemplary embodiments given by way of non-limiting illustration, with reference to the appended schematic drawings, in which:

FIG. 1 is a perspective depiction of the radiator according to the invention;

FIG. 2 is an exploded view of the electric radiator depicted in FIG. 1;

FIG. 3 is a perspective view of a temperature sensor support provided on the electric radiator in FIGS. 1 and 2;

FIG. 4 is a detail view of the support in FIG. 3, from a different perspective angle, more particularly showing a guide member of an electronic connection element associated with the temperature sensor;

FIG. 5 is a vertical cross-section of an electric radiator similar to the one depicted in FIG. 1, showing an alternative embodiment of a separating wall between a heating body and an electronic control device of the radiator, the separating wall being formed by a bottom wall of a housing of the electronic control device;

FIG. 6 is a transverse cross-section of an electric radiator similar to the one depicted in FIG. 1, showing an alternative embodiment of a separating wall between a heating body and an electronic control device of the radiator, the separating wall being formed by a bottom wall of a housing of the electronic control device and by an additional element;

FIG. 7 is a perspective view of a heating body of the electric radiator depicted in FIG. 1, with an additional element depicted in an exploded view;

FIG. 8 is a view from a similar perspective to FIG. 7, in which the additional element is mounted on the heating body; and

FIG. 9 is a bottom view of a housing of the electric radiator, showing a bottom wall intended to face the heating body in FIGS. 7 and 8.

### DETAILED DESCRIPTION OF THE INVENTION

The features, variants and different embodiments of the invention can be combined with one another, in various combinations, provided that they are not mutually incompatible or mutually exclusive. In particular, it is possible to envisage variants of the invention that comprise only a selection of features described below, independently of the other features described, if this selection of features is sufficient to confer a technical advantage and/or to differentiate the invention from the prior art.

In the figures, elements that are common to multiple figures retain the same reference sign.

In the following detailed description, the terms “longitudinal”, “transverse” and “vertical” refer to the orientation of a distribution system according to the invention. A longitudinal direction corresponds to a main direction of elongation of a heating element, this longitudinal direction being parallel to a longitudinal axis L of a coordinate system L, V, T illustrated in the figures. A transverse direction corresponds to a direction in which a separating wall of the radiator mainly extends, this transverse direction being parallel to a transverse axis T of the coordinate system L, V, T, and this transverse axis T being perpendicular to the longitudinal axis L. Finally, a vertical direction corresponds to a direction parallel to a vertical axis V of the coordinate system L, V, T, this vertical axis V being perpendicular to the longitudinal axis L and the transverse axis T and in addition corresponding to the direction of circulation of the air flow through the electric radiator.

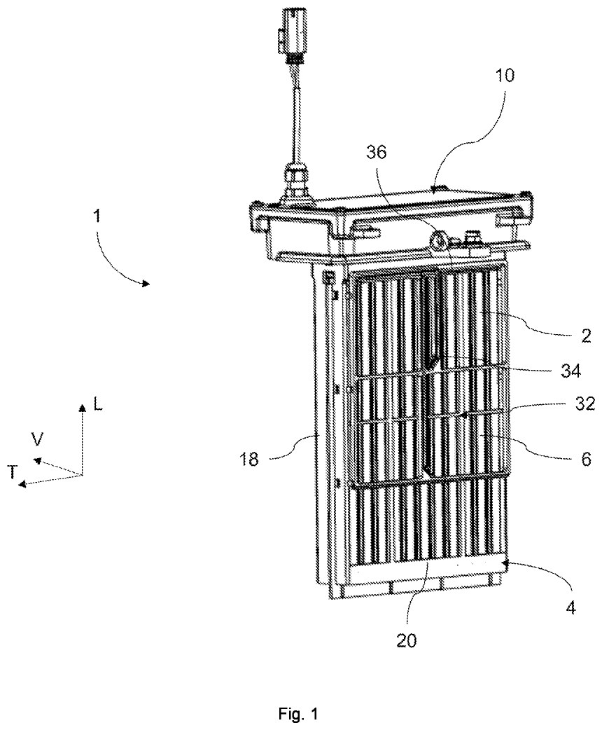

FIG. 1 illustrates an electric radiator 1 according to the invention, configured to be installed in a ventilation, heating and/or air-conditioning system of a vehicle. The electric radiator 1 is used in this type of system to heat an air flow circulating through said electric radiator 1 for example.

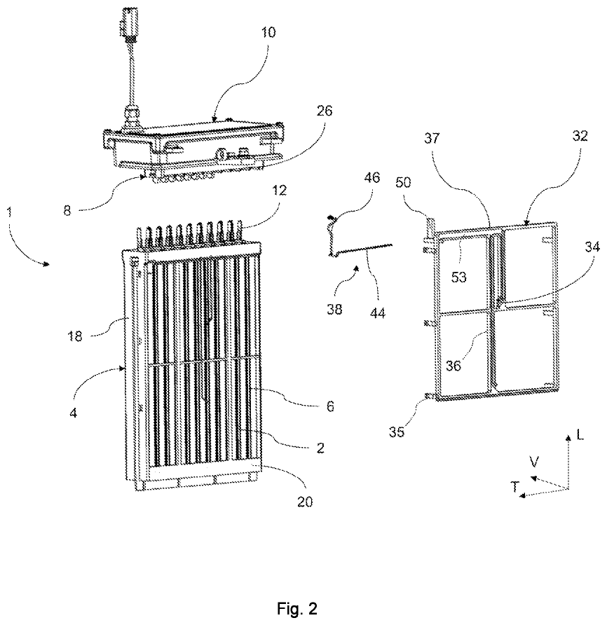

To this end, and as can be seen in FIGS. 1 and 2, the electric radiator 1 comprises at least one heating element 2 contributing to the formation of a heating body, which here is delimited by a frame 4 contributing to at least partially defining a recess 6 for receiving at least one heating element 2, an electronic device 8 for controlling the at least one heating element 2 and a housing 10 accommodating the electronic control device 8. The electronic control device 8 is electrically and/or electronically connected to the at least one heating element 2 in order to transmit a command instruction to it, for example.

In the example illustrated, the heating body is delimited by a frame 4, and the housing 10 and this frame 4 are in addition rigidly connected to each other. It should be noted that the heating body could have a different shape and not have a frame, without any need to modify the features specific to the invention, and in particular the feature whereby a passage is formed in a separating wall between the housing and the heating body for an electronic connection element associated with a temperature sensor, which will be described hereinafter.

The at least one heating element 2 comprises at least one member 12 for coupling to the electronic control device 8, the coupling member 12 be more particularly visible in FIGS. 2 and 5 to 8. Here, the coupling member 12 makes it possible to provide electric and/or electronic communication between the at least one heating element 2 and the electronic control device 8.

In addition, and as illustrated in FIG. 1, the at least one heating element 2 takes the form of a tube extending along the longitudinal direction L. The tube has at least one outer surface intended to be electrically heated, and to be in contact with an air flow in order to heat it. The heating element 2 has a distal longitudinal end and a proximal longitudinal end bearing the coupling member 12.

The frame 4 that here forms the heating body defines the recess 6 for receiving the at least one heating element 2. To this end, the frame 4 has two longitudinal walls 18 extending in planes that are separate from each other and parallel to the longitudinal L and vertical V directions, and two transverse walls 20 extending between the two longitudinal walls 18, in planes that are separate from each other and parallel to the transverse T and vertical V directions. According to the example depicted here, the at least one heating element 2 extends between the two transverse walls 20 of the frame 4.

Here, the electric radiator 1 comprises a plurality of heating elements 2 positioned alongside each other along the transverse direction T. In this advantageous configuration, an air flow circulating through the electric radiator 1 circulates between the heating elements 2, thus optimizing the exchange of heat. In addition, the electric radiator 1 can comprise radiating elements, for example in the form of corrugated sheets, positioned between the heating elements 2 to increase the contact area between the air and the elements capable of delivering heat energy.

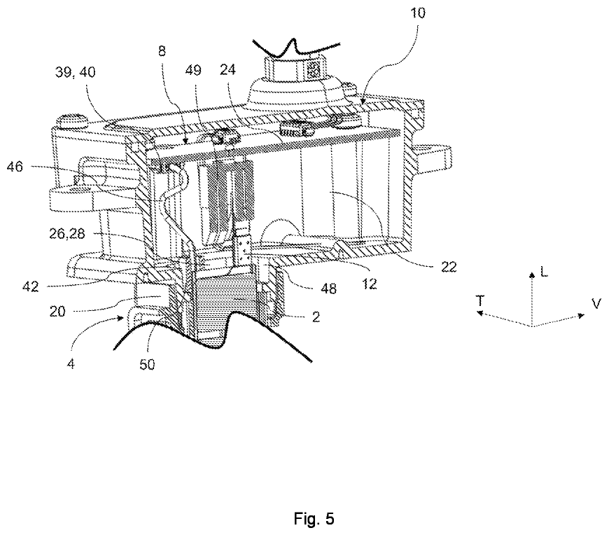

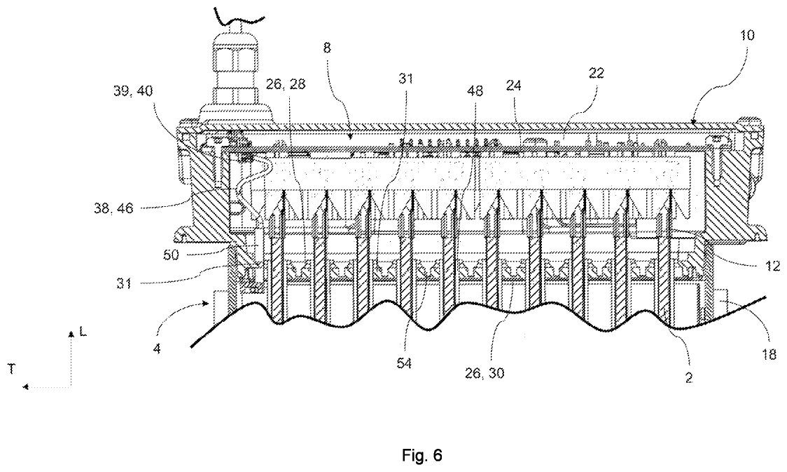

As depicted in FIGS. 5 and 6, the electronic control device 8 is accommodated in the housing 10 rigidly connected to the frame 4. The housing 10 comprises a plurality of walls arranged in the form of a rectangular parallelepiped, the walls defining a receiving space 22 in which at least the electronic control device 8 is installed.

Here, the electronic control device 8 comprises a printed circuit board 24 on which are installed electronic components capable of transmitting and/or generating command instructions at least to the heating element 2.

As can be seen more particularly in FIGS. 5 and 6, the electric radiator 1 comprises a separating wall 26 between the space 22 for receiving the electronic control device 8, and the heating element(s) 2. This separating wall 26 thus provides a physical demarcation between the housing 10 and the heating body, here represented by the frame 4 and the recess 6 for receiving the heating elements 2.

The separating wall 26 is arranged in the vicinity of a bottom wall 28 of the housing, which contributes to the formation of this separating wall. According to one alternative, illustrated in particular in FIG. 5, the bottom wall 28 directly forms the separating wall 26 between the housing 10 and the receiving recess 6.

According to one alternative, illustrated in FIGS. 6 to 8, the electric radiator 1 comprises an additional element 30 that contributes to the formation, with the bottom walls 28, of the separating wall 26. This additional element 30 is installed between the bottom wall 28 of the housing 10 and the heating body.

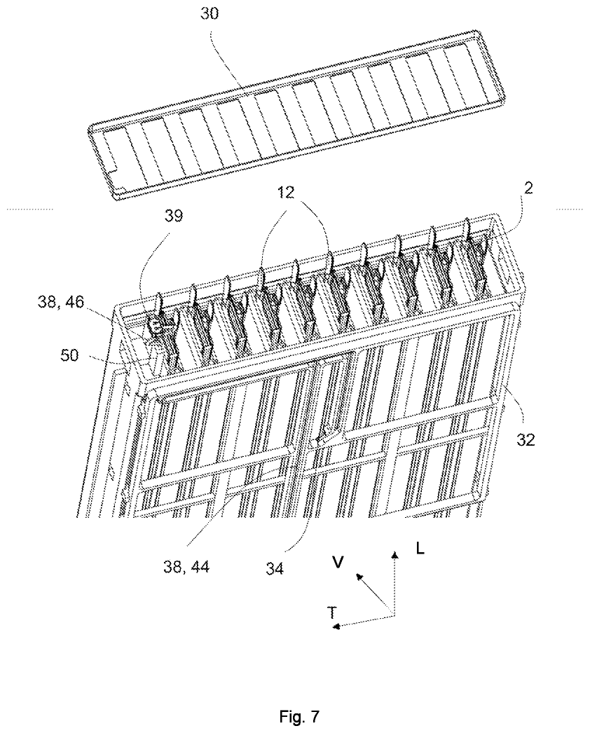

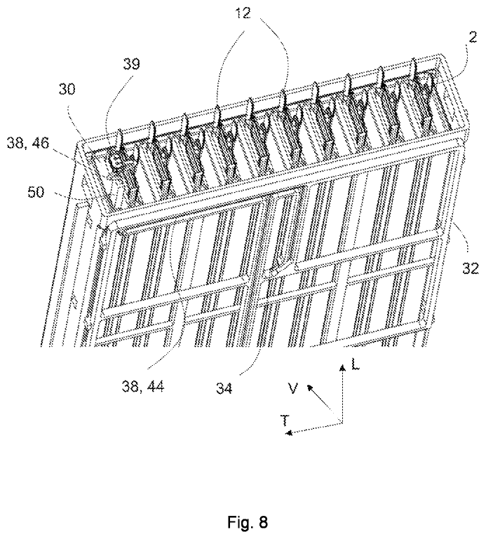

The additional element 30 can be seen in particular in FIGS. 7 and 8, in a position at a distance from the heating body and the heating elements and in an assembled position on the heating body respectively. It will be understood that the additional element has shapes that complement the heating elements in order to form a closing wall of the heating body on the face intended to be facing the housing of the electronic control device. As will be described in greater detail below, these figures show in particular the presence of openings 48 each intended to surround a heating element and an orifice 42 intended to surround an element 50 for guiding an electronic connection element 38.

As illustrated in FIGS. 1 and 2, the electric radiator 1 comprises a support 32 for a temperature sensor 34 installed on the frame 4. More specifically, the support 32 is positioned at least partially covering the receiving recess 6, that is, it extends across a circulation zone of an air flow capable of passing through the frame between the heating elements.

The support 32, as depicted here, takes the form of a grille on which the at least one temperature sensor 34 is installed. Here, the term grille refers to a structure comprising a set of bars 36, 37 at least one of which extends across the heating body formed by the plurality of heating elements. The temperature sensor 34 is positioned on one of these bars and the arrangement in the form of a grille makes it possible both to provide rigid and reliable positioning of the temperature sensor on one of the bars extending across the heating body, and to allow the passage of the air flow passing through the heating body. More particularly, the support 32 comprises a plurality of bars separated into longitudinal bars 36, extending mainly along the longitudinal direction L, and transverse bars 37, mainly extending along the transverse direction T, so as to form a grid.

Longitudinal and transverse bars form an outline of the support on which attachment means 35 are positioned.

The temperature sensor 34 is intended to measure the temperature of the at least one heating element 2 and/or of the air flow circulating around the at least one heating element 2. To this end, the temperature sensor 34, as illustrated in FIG. 2, is installed on a longitudinal bar 36 of the grille, and more particularly on a longitudinal bar 36 centered relative to the walls of the frame 4.

The temperature measurements gathered in this way are transmitted to the electronic control device 8 via an electronic connection element 38 making it possible to electrically connect the temperature sensor 34 to the electronic control device 8. The connection element 38 can in particular take the form of an electrical cable connected to the temperature sensor 34 and, via an electrical connection end fitting 39, to the electronic control device 8. More specifically, this cable extends between the temperature sensor 34 and a connection block 40 of the printed circuit board 24 of the electronic control device 8, the connection block 40 and the electrical connection end fitting 39 being configured to cooperate.

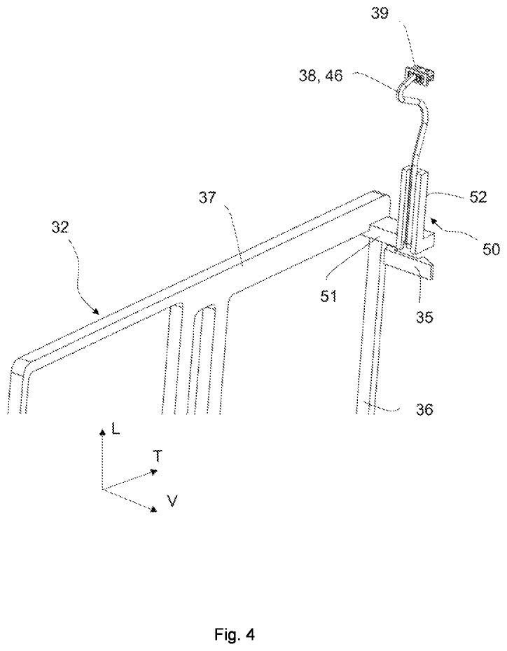

According to the invention, and as can be seen more particularly in FIGS. 5 to 9, the separating wall 26 comprises at least one orifice 42 configured to be passed through by the connection element 38. As will be described in greater detail below, with particular reference to FIGS. 2 to 6, the electronic connection element 38 is associated with a guide member 50 of the support 32, which protects and guides the electronic connection element through the separating wall 26.

The orifice 42 passes through the separating wall 26 along the longitudinal direction L so as to emerge longitudinally on either side of the separating wall and provide a passage between the heating unit formed by the heating elements and the housing of the electronic control device 8, this orifice 42 being sized so that it can be passed through by the electronic connection element 38 and the associated guide member 50.

As a result of this configuration, a first portion 44 of the connection element 38 can be defined, in contact with the temperature sensor 34 extending mainly along the support 32 between the temperature sensor 34 and the orifice 42 of the separating wall 26, and a second portion 46 of the connection element 38 extending between the electronic control device 8 and the orifice 42 of the separating wall 26.

The connection element 38 can thus be protected between the electronic control device 8 and the temperature sensor 34, whether inside the housing of the electronic control device 8 or along the support along which it extends to the temperature sensor.

The orifice 42 is formed in the bottom wall 28, in particular in the alternative of the invention in which only the bottom wall 28 forms the separating wall 26. In the alternative in which an additional element 30 contributes to the formation of the separating wall 26 with the bottom wall 28, this additional element 30 and the bottom wall 28 each comprise an orifice 42, the orifice 42 of the bottom wall 28 being longitudinally aligned with the orifice 42 of the additional element 30, each of the orifices 42 being configured to be passed through by the connection element 38. Here, the orifices 42 are aligned to form a single duct through which the connection element 38 extends.

As illustrated, the separating wall 26 comprises an opening 48 through which the at least one heating element 2, and more particularly here the coupling member 12 of the heating element 2, extends. One opening 48 is formed in the separating wall for each of the heating elements, so that each heating element can be electrically connected to the printed circuit board accommodated in the electronic control device, in particular via a transistor 49 visible in FIG. 5.

It will be understood that the opening 48 is an orifice passing through the separating wall 26, that is, the bottom wall 28 of the housing 10 and/or the additional element 30, through which extends at least one heating element 2 and advantageously the associated coupling member 12.

In the example illustrated, the separating wall 26 comprises a plurality of openings 48 formed alongside each other and sized so that they can respectively receive and be passed through by a heating element 2 and/or an associated coupling member 12. The openings 48 are positioned alongside each other so as to form a row along the transverse direction T.

The orifice 42 configured to be passed through by the electronic connection element 38 communicates with one of said openings 48. This configuration makes it possible to use just one orifice to pass both the connection element 38 and the coupling member 12 of one of the heating elements 2 and facilitates the management of manufacturing tolerances during the assembly of the electric radiator.

More particularly, the orifice 42 configured to be passed through by the electronic connection element 38 is positioned in the vicinity of one of the transverse ends of the separating wall 26, so that it communicates with one of the two openings 48 positioned at the transverse end of the transverse row of the plurality of openings 48. In other words, one of the openings 48 positioned at the transverse ends of the separating wall 26 communicates with the orifice 42 of the separating wall 26 as described previously.

As a result of the above, the electronic connection element 38 extends through the separating wall 26 to pass from the heating body to the electronic control device, without diverting outside the housing 10, which facilitates the assembly of the electric radiator 1 and the coupling between the temperature sensor 34 and the electronic control device 8. In particular, it is possible to seal the inlet for the electronic connection element 38 in the electronic control device in the same operation as sealing the coupling members 12. This avoids an additional assembly operation, which is necessary in the prior art, to pass the cable into a through-orifice formed in a peripheral wall of the housing other than the separating wall, and avoids an additional sealing action, which is necessary in the prior art, to close a through-orifice for the cable in such a peripheral wall.

As stated above, the support 32 comprises a member 50 for guiding the connection element 38 protruding from the support 32 toward the electronic control device 8, the guide member 50 extending through the separating wall 26 in said orifice 42. Advantageously, the guide member 50 is made from a more rigid material than the connection element 38 and thus contributes to mechanically guiding the connection element 38 from the support 32 toward the electronic control device 8 through the orifice 42 of the separating wall 26.

Here, the guide member 50 is formed in a corner of the grille forming the support 32, at the junction between a longitudinal bar 36 bearing attachment means 35 of the support, and a transverse bar 37.

As can be seen in particular in FIGS. 2 to 6, the guide member 50 is configured to guide the electronic connection element 38 at a distance from the grille forming the support 32. More particularly, the guide member 50 comprises a first part 51 that extends vertically from the support 32 to convey the electronic connection element 38 to the separating wall 26, and a second part 52 that extends the first part 51 by extending longitudinally in order to guide the electronic connection element through the separating wall toward the printed circuit board 24.

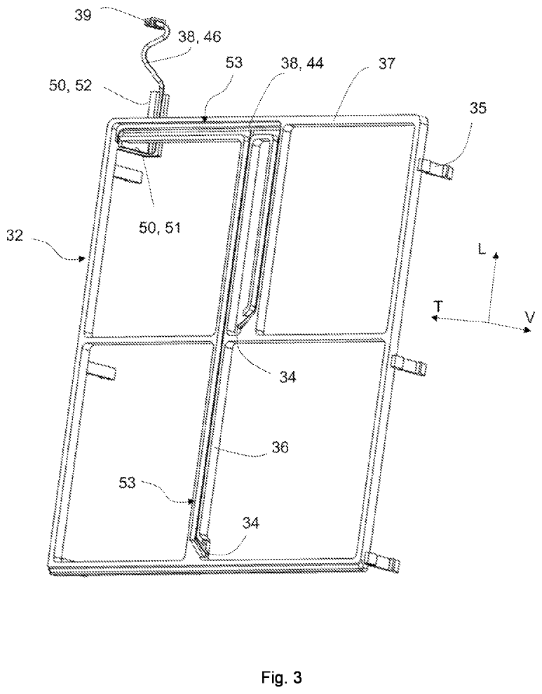

It will be noted that the electronic connection element 38 is protected along its full extent. The first portion 44 of the connection element 38, in contact with the temperature sensor 34, extends firstly in a cavity 53 formed in an outer face of the support 32, that is, a face facing in the opposite direction to the heating elements, particularly visible in FIGS. 2 and 3, the cavity emerging into an aperture in order to make it possible to position the temperature sensor facing the heating body without interposition of the support 32.

It should be noted that the cavity 53 is formed continuously on a longitudinal bar 36, which makes it possible to position the temperature sensor 34, at the free end of the connection element 38, at a distance from the electronic control device 8, and on a transverse bar 37, which makes it possible to convey the electronic connection element 38 toward the corner of the grille in which the guide member 50 is formed.

The cavity 53 formed in the transverse bar emerges continuously onto a groove formed in the first part 51 of the guide member, the first portion 44 of the connection element 38 thus extending successively in cavities and grooves capable of protecting and guiding it.

At least on the second part 52 of the guide member 50, that is, the part intended to pass through the orifice 42 formed to this end in the separating wall 26, the guide member has a U-shaped profile when viewed in a cross-section perpendicular to the main direction of extension, here the longitudinal direction. More particularly, this U shape is obtained by a central wall and two lateral walls each extending from one of the ends of the central wall in the same direction parallel to each other, the connection element 38 being positioned between each of these walls of the guide member 50, in the hollow of the U shape of the guide member 50. One of the walls is pierced so that the groove formed in the first part 51 of the guide member emerges into the hollow of the U shape of the second portion 52 of the guide member and so that the electronic connection element 38 is thus constantly protected.

According to the invention, the electric radiator 1 comprises at least one sealing element 31 installed between the guide member 50 and the edges defining the orifice 42 in the separating wall 26, the sealing element 31 being visible in FIG. 6. The sealing element 31 prevents the circulation of at least one fluid at least through the orifice 42 of the separating wall 26, hermetically sealing the housing 10 in which the electronic control device 8 of the heating body formed by the heating elements 2 is accommodated. It will be understood that the sealing element extends so as to form, once hardened, a sealing wall around the connection element 38 and the guide member 50 in the orifice 42.

The sealing element can for example be a material that is deformable when applied, that spreads out in the space in which it is positioned and then hardens when heated. The sealing element can in particular consist of an elastomeric material, for example silicone, or an adhesive, and this sealing element can be applied for example by potting.

According to the alternative of the invention in which the separating wall is formed by both the bottom wall 28 and the additional element, the sealing element can extend around the guide member 50 in each of the orifices 42 of the bottom wall 28 and the additional element 30.

It will be noted that the sealing operation, which consists of applying a sealing element to the separating wall 26, and if applicable the additional element 30, can be carried out so as to simultaneously seal the orifice 42 through which the electronic connection element 38 passes and the openings 48 through which the heating elements and the corresponding coupling member pass.

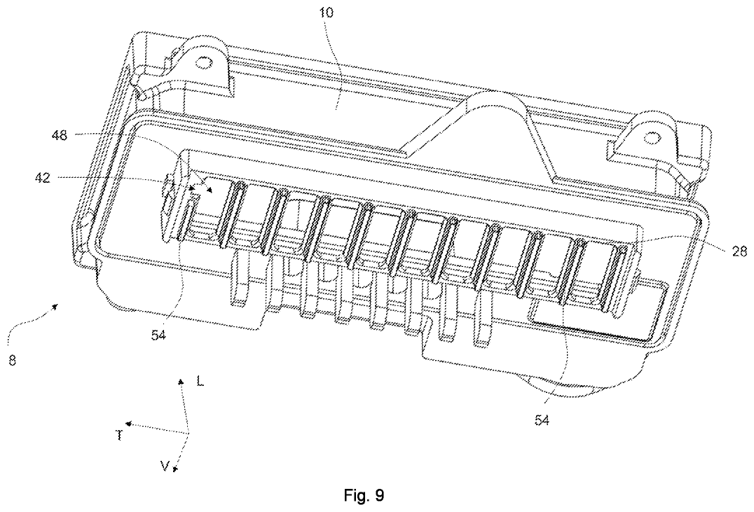

As can be seen in FIG. 9, the bottom wall 28 of the housing 10 has on its outer face, that is, the face intended to be facing the additional element 30 in the corresponding alternative of the invention, ribs 54 intended to be in contact with the additional element. These ribs 54 make it possible to disperse the sealing element applied to the additional element and to ensure that this sealing element is pushed toward the openings and orifices that need to be filled.

A method will now be described for assembling an electric radiator 1 as described above, and more particularly the alternative thereof with an additional element 30 contributing to the formation of the separating wall 26. This method comprises a first step of assembling the heating body with the at least one heating element 2 and the support 32 for the temperature sensor 34, during which the additional element 30 is positioned relative to the heating elements 2 and the guide member 50 so that the guide member 50 passes through the orifice 42 and the heating elements and the coupling members 12 respectively pass through their associated opening 48. This method also comprises a second sealing step during which a sealing element is positioned in the additional element 30 around the openings 48 and the orifice 42, and during which the housing 10 of the electronic control device 8 is placed against the heating body before the sealing element is polymerized.

Prior to the first assembly step, the temperature sensor 34 and the electronic connection element 38 are installed on the support 32, by accommodating the connection element 38 in the cavity 53 and in each of the grooves formed in the guide element 50. The assembly formed by the temperature sensor 34, the connection element 38 and the support 32 is then installed on the heating body, and in particular here against the frame 4 provided with these heating element 2, before being fastened by cooperation of the attachment means 35 rigidly connected to the support 32 with the frame 4. It will be noted here that the support 32 is assembled on the heating body in two stages, with a first translational movement along an axis inclined relative to the main longitudinal and transverse plane of extension, so as to accommodate the guide element 50 through the orifice 42, and then a second tilting movement allowing the cooperation of the attachment means with the frame. It will be understood that the dimension of the orifice 42 is greater than the corresponding dimension of the guide element in order to allow the insertion of the guide element during the first inclined translational movement, the sealing element making it possible to fill the orifice 42 once the guide element 50 is in place. The connection element 38 can then be connected to the electronic control device 8 via the appropriate coupling means 39, 40.

As described above, the invention achieves the stated aim, namely that of proposing an electric radiator provided with a temperature sensor the assembly and sealing of which are not complicated by the presence of this temperature sensor and a support for this temperature sensor. The present invention is not however limited to the means and configurations described and illustrated herein, and also extends to all equivalent means and configurations and to any technically operational combination of such means, provided that it comprises an electronic connection element connecting a temperature sensor to the electronic control device and that the electric radiator is configured so that this electronic connection element passes internally, through a separating wall between the heating body of the radiator and this electronic control device.

What is claimed is:

1. An electric radiator of a ventilation, heating and/or air-conditioning system of a motor vehicle, comprising at least one heating element forming a heating body and an electronic device for controlling the at least one heating element, accommodated in a housing, the heating body and the housing being rigidly connected to each other, with a separating wall arranged between the housing and the heating body, and at least one support for at least one temperature sensor, the at least one support being positioned at least partially covering the at least one heating element of the heating body, with an electronic connection element between the at least one temperature sensor and the electronic control device, where the separating wall includes at least one orifice configured to be passed through by the electronic connection element.

2. The electric radiator as claimed in claim 1, wherein the at least one support includes a guide member for guiding the connection element protruding from the at least one support toward the electronic control device, the guide member extending through the separating wall in said at least one orifice.

3. The electric radiator as claimed in claim 2, wherein the guide member has a first part, which extends perpendicular to the main plane of extension of the at least one support, and a second part that extends the first part toward the electronic control device and is positioned through the at least one orifice formed in the separating wall, the electronic connection element being positioned along the first part and the second part of the guide member.

4. The electric radiator as claimed in claim 1, wherein the at least one support takes the form of a grille in which the at least one temperature sensor is installed, the grille being positioned facing the heating body.

5. The electric radiator as claimed in claim 1, wherein the housing includes a plurality of walls that contribute to a definition of a space for receiving the electronic control device, wherein at least a bottom wall of the plurality of walls takes a form of a bowl and forms said separating wall.

6. The electric radiator as claimed in claim 1, further comprising an additional element installed between the housing and the heating body, the additional element contributing to the formation of said separating wall.

7. The electric radiator as claimed in claim 6, wherein the housing includes a plurality of walls that contribute to a definition of a space for receiving the electronic control device, wherein at least a bottom wall of the plurality of walls takes a form of a bowl and forms said separating wall, wherein the bottom wall and the additional element each include the orifice, the orifice of the bottom wall being aligned with the orifice of the additional element, with each of the orifices being configured to be passed through by the electronic connection element.

8. The electric radiator as claimed in claim 1, further comprising at least one sealing element installed between the guide member and the separating wall.

9. The electric radiator as claimed in claim 1, wherein the separating wall includes an opening through which the at least one heating element and a coupling member of the at least one heating element extend, the at least one orifice being configured to be passed through by the electronic connection element communicating with said opening.

10. The electric radiator as claimed in claim 9, comprising wherein the at least one heating element includes a plurality of heating elements installed alongside each other, the separating wall including a set of openings installed alongside each other and sized so as to respectively receive and be passed through by a heating element of the plurality of heating elements, the at least one orifice configured to be passed through by the electronic connection element communicating with one of the two openings positioned at the end of the set of openings.

11. A ventilation, heating and/or air-conditioning system comprising at least one circulation duct capable of directing an air flow, at least one ventilation member forcing the circulation of the air flow through the circulation duct and an electric radiator installed in the duct, the electric radiator including at least one heating element forming a heating body and an electronic device for controlling the at least one heating element, accommodated in a housing, the heating body and the housing being rigidly connected to each other, the electric radiator including a separating wall arranged between the housing and the heating body, the electric radiator including at least one support for at least one temperature sensor, the at least one support being positioned at least partially covering the at least one heating element of the heating body, the electric radiator including an electronic connection element between the at least one temperature sensor and the electronic control device, wherein the separating wall includes at least one orifice configured to be passed through by the electronic connection element, the at least one heating element being installed across the circulation duct.

12. The electric radiator as claimed in claim 1, wherein the separating wall includes an opening through which the at least one heating element or the coupling member of the at least one heating element extends, the at least one orifice being configured to be passed through by the electronic connection element communicating with said opening.
